(19) United States
(12) Patent Application Publication
(10) Pub. No.: US 2004/0107778 A1
(43) Pub. Date: Jun. 10, 2004

(54) Vortex-frequency flowmeter

(76) Inventor: Oliver Berberig, Hannover (DE)

Correspondence Address: Richard C Woodbridge, Synnestvedt Lechner & Woodbridge, PO Box 592, Princeton, NJ, 08542-0592, US

(21) Appl. No.: 10/475,226

(22) PCT Filed: Apr. 17, 2002
(86) PCT No.: PCT/DE02/01428

(30) Foreign Application Priority Data
Apr. 17, 2001 (DE) 101 18 810.2

(51) Int. Cl. G01F 1/32

(52) U.S. Cl. 73/861.22

(57) ABSTRACT

The present invention relates to a vortex frequency flow meter for determining the rate of flow of a liquid or gaseous medium through a pipeline with an obstructor (bluff body) mounted therein, said obstructor comprising lateral surfaces arranged essentially parallel to the flow and terminating in both directions of flow at vortex shedding edges, whereby at least one sensor for detecting vorteces periodically shedding from the shedding edges is disposed in at least one of said lateral surfaces. It is the object of the invention to develop such a vortex frequency flow meter in such a manner that it allows not only measuring operation in both directions of flow, but also a determination of the direction of flow using simple means. This task is solved in that the at least one sensor (16) is disposed off-centre—as seen in the direction of flow (20, 21)—between the shedding edges (8, 8.1; 9, 9.1).

The present invention relates to a vortex frequency flow meter for determining the rate of flow of a liquid or gaseous medium through a pipeline in accordance with the preamble of claim 1.

Vortex frequency flow meters utilize the periodical vortex shedding at a blunt obstructor (bluff body) located in the fluid flow. Hereby, the phenomenon exists that vorteces are shedded alternatingly from opposing sides of the obstructor surface facing the flow. Thereby, a so-called von-Karman vortex street is created, i.e. the vorteces remain active for a certain distance behind the obstructor in the flow prior to being desolved. Vortex frequency flow meters utilize the finding that for certain obstructor profiles there exists a linear dependency between the frequency of vortex shedding and the speed of flow over a large area of low speeds, in other words, the speed of flow and therewith the flow volume of the fluid through the pipeline can be directly derived from determining this frequency. Thus, besides an obstructor, sensor means for determining the vortex sheddings or, respectively, the changes in parameters of the flowing fluid (e.g. pressure, speed, temperature) resulting thereform form part of a measuring assembly of the type of a vortex frequency flow meter.

In the case of vortex frequency flow meters first described in literature and firstly commercially utilized the obstructor consists of a rod chaped profile extending diametrally in the cross section of the flow. Examples for vortex frequency flow meters with such obstructor bodies can be found in GB 1 401 272, U.S. Pat. No. 4,206,642, U.S. Pat. No. 4,285,247, DE 37 14 344 C2, DE 41 02 920 C2, U.S. Pat. No. 3,979,954, EP 0 077 764, U.S. Pat. No. 4,434,668, U.S. Pat. No. 4,922,759, U.S. Pat. No. 5,214,965, U.S. Pat. No. 5,321,990 and EP 0 666 468.

Later vortex frequency flow meters with ring shaped obstructors were developed. In comparison with rod shaped obstructors these exhibit, in the case of identical absolute blocking of the cross section of a flow (loss of pressure), a smaller width of profile. Resulting therefrom is a higher vortex frequency at identical flow velocities, i.e. the measuring accuracy is improved in comparison to rod shaped obstructors. Examples for vortex frequency flow meters utilizing ring shaped obstructors can be found in GG 1 502 260, WO 88/04410, DE 32 20 539, DE 28 02 009, U.S. Pat. No. 5,170,671, U.S. Pat. No. 5,289,726, JP 560 22 963, JP 59 19 8317, JP 11 48 912, JP 11 48 913 and JP 11 48 914. Vortex frequency flow meters with ring shaped obstructors were never realized in practice to-date, however.

DE 28 02 009 describes a vortex frequency flow meter with a ring shaped obstructor. In one embodiment this obstructor exhibits a rectangular cross section, i.e. it has lateral surfaces lying in parallel to the direction of flow and terminating at vortex shedding edges in both directions of flow, whereby the cross section of the obstructor between the shedding edges is symmetrical in the direction of flow as well as perpendicular to that. Thus, it is suitable for measuring the flow in both directions. Radial tie bars serve to keep the obstructor mounted concentrically within the pipeline. For the purpose of determining the vortex shedding at the obstructor pressure or velocity sensitive measuring sensors are provided at the obstructor itself or in its vicinity, for example, pipeline wall. More detailed specifications regarding the location and construction of such measuring sensors have not been disclosed in DE 28 02 009.

GB 1 401 272 describes a vortex frequency flow sensor with a rod shaped obstructor likewise allowing for flow measurements in both directions. This obstructor is provided radially and axially centrically with a through bore extending from one lateral surface of the obstructor to the other and being closed on both sides by membranes aligned in a formfit manner with the lateral surfaces. The through bore is filled with oil, so that the membranes are hydraulically communicating. Within the through bore a piezoelectrical sensor is disposed which detects the pressure pulses transmitted through the membranes because of the vortex sheddings via the oil medium.

It is the object of the present invention to provide a vortex frequency flow meter not only allowing measuring operation in both directions of flow, but also allowing determination of the direction of flow using simple means.

This task is solved in accordance with the invention by a vortex frequency flow meter according to the features of claim 1.

Simply by virtue of the fact that the at least one sensor, which is present and required anyway, is disposed in the direction of flow off-centre (not in the middle) between the shedding edges, it is not only possible to measure in both directions of flow, but in addition to also determine the direction of flow. This effect results from the fact that the change in parameters, e.g. pressure, temperature and velocity, resulting from the vortex shedding are different in the two directions of flow due to the axial displacement of the at least one sensor as opposed to a central disposition between the shedding edges, so that based upon these differences the direction of flow can be detected. Additional expenditure as regards the design of the vortex frequendy flow meter as well as additional measuring facilities ore not required for this solution. However, this advantage comes at the expense of a higher complexity of data processing in that the actual measured frequency and amplitudes is compared with frequency amplitude pairs determined under defined conditions whose combinations are uniquely associated with a certain direction of flow.

In a further embodiment of the invention the complexity of signal processing can be reduced in that the at least one sensor is associated with a second sensor disposed displaced in the direction of the flow compared with the first and disposed on the same thread of flow. In such an arrangement of sensors the direction of flow can be determined without comparison with stored frequency amplitude pairs in that the actual measured amplitudes are directly compared with each other whereby the direction of flow is determined from the amplitude difference. Possibly, unter suitable conditions, the temporal displacement of the signals of both sensors can be used for determining the direction of flow.

Instead of the two sensors being displaced one behing the other in the direction of flow, the sensors may be distributed over the height of a rod shaped obstructor or over the circumference of a ring shaped obstructor respectively, and disposed in a manner displaced against each other in the direction of flow. Such an arrangement would yield, in addition to the advantage of the determination of the direction of flow, the additional advantage of allowing the detection of a symmetry of flow. It is apparent that using a higher number of sensors increases the accuracy of the detection of a symmetry.

It is of advantage if the sensors are disposed in opposing directions off-centre between the shedding edges, i.e. their spacing being as large as possible, because in that case the signal difference in both directions of flow is at its highest.

In view of this, it is advantageous to utilize microsensors in realizing the invention. Such sensors can be disposed, due to their small dimensions, in a very near vicinity of the shedding edges so that on the one hand an optimum large spacing between axially ?despaced? sensors ensues and on the other hand a strong signal is generated.

A second advantage ensues when in embodying the invention with measuring points lying on opposite sides of the lateral surfaces of the obstructor these measuring points are connected via through bores. This serves to add the respective drops and boosts of pressure so that compaired to measuring points without such a connection a double pressure amplitude ensues resulting in a very high measuring sensitivity. Thus, this solution would be most suitable for differential pressure sensors.

Furthermore, it is of advantage if the through bores are closed by membranes essentially aligned in a formfit manner with the surfaces of the exterior side and the interior side. This serves to prevent blocking of the through bores as well as the generation of perpendicular flow through the through bores disturbing the generation of vorteces.

The invention is subsequently further illustrated by means of embodiment examples. The accompanying drawing shows in:

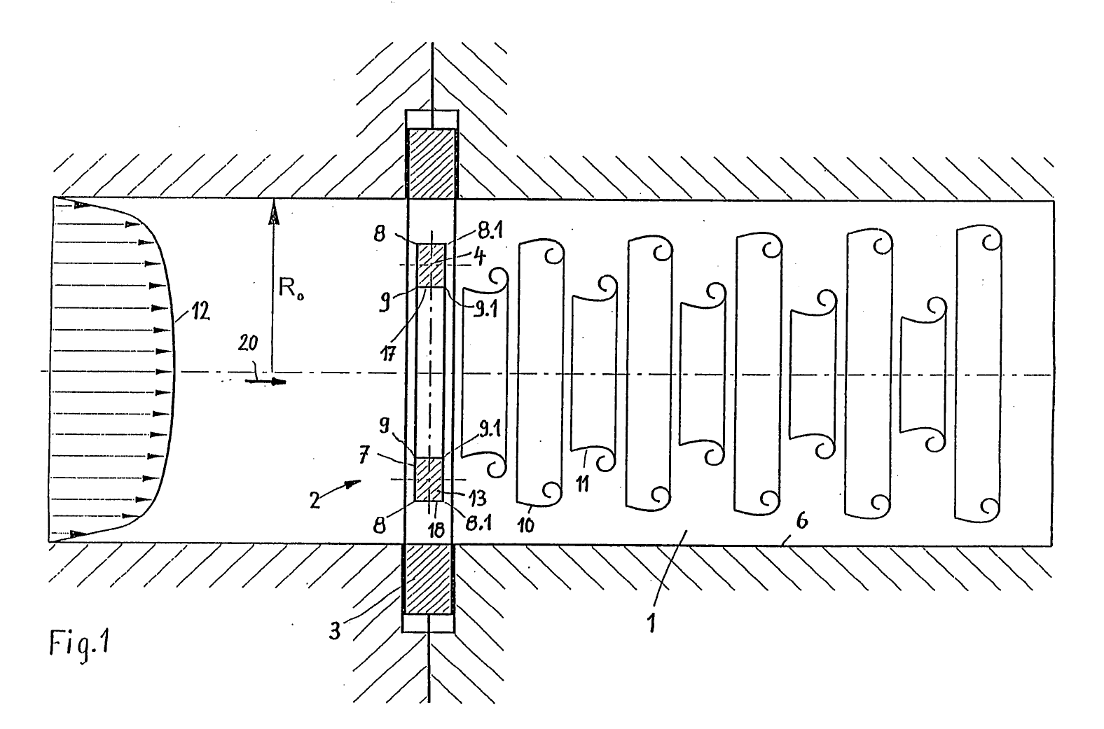

FIG. 1 a principal cross section of a vortex frequency flow meter mounted in a pipeline with a ring shaped obstructor and a von-Karman vortex street created behind the same;

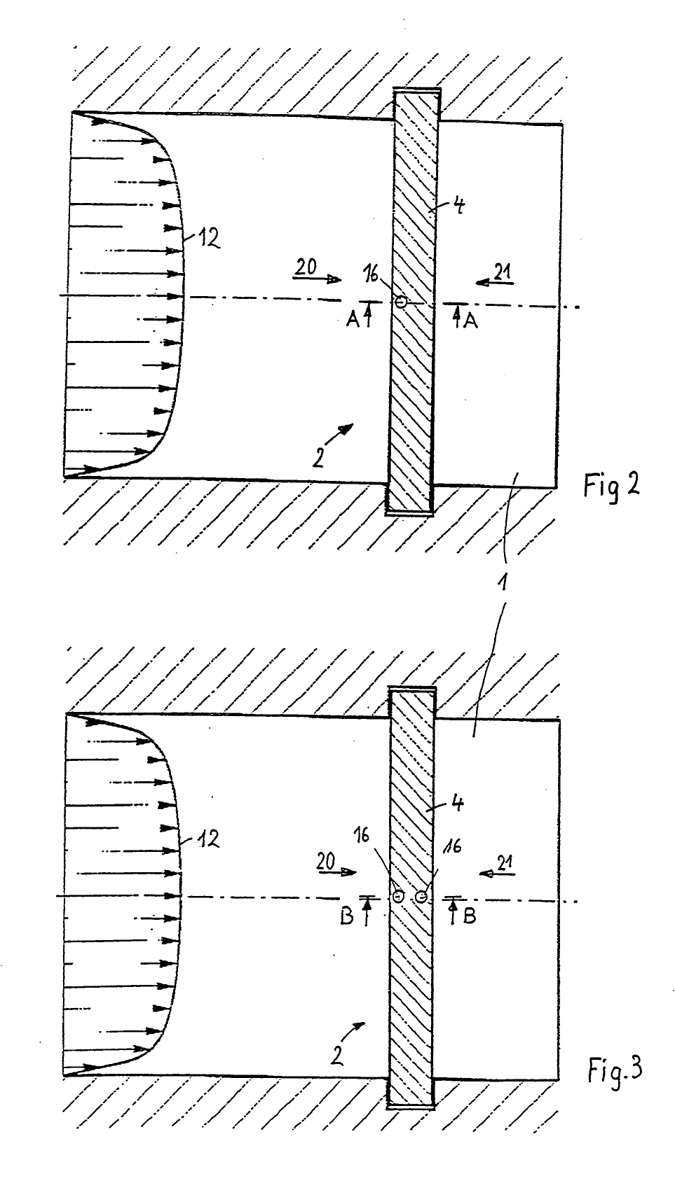

FIGS. 2-8 a principal cross sectrion of a vortex frequency flow meter mounted in a pipeline with a rod shaped obstructor and various sensor arrangements;

FIG. 9 a principal pressure time diagram to illustrate the signal differences of both directions of flow;

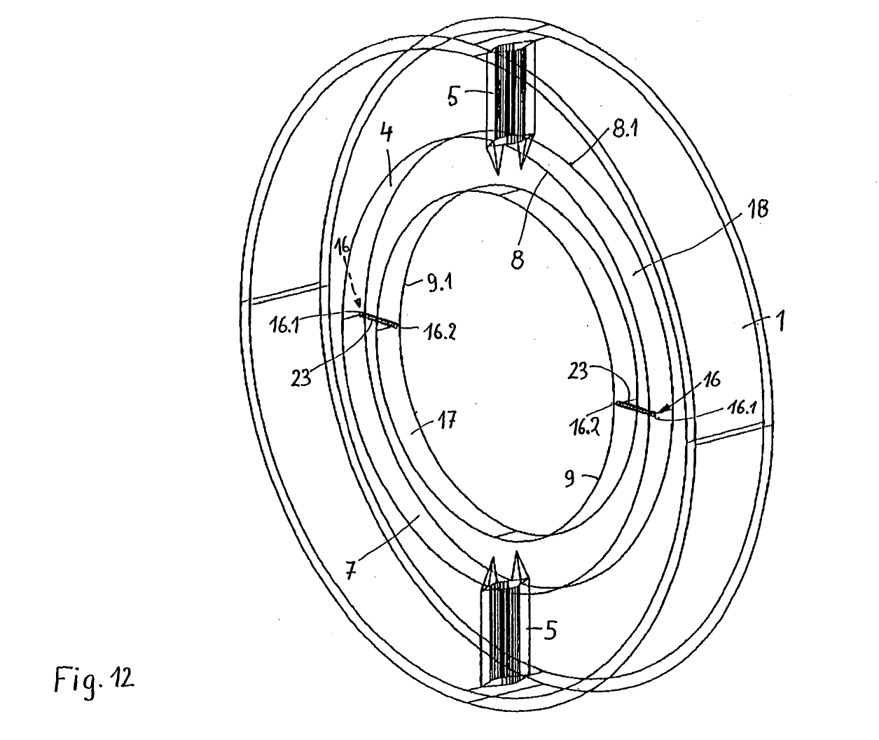

FIG. 10 a section A-A according to FIG. 2 enlarged in scale;

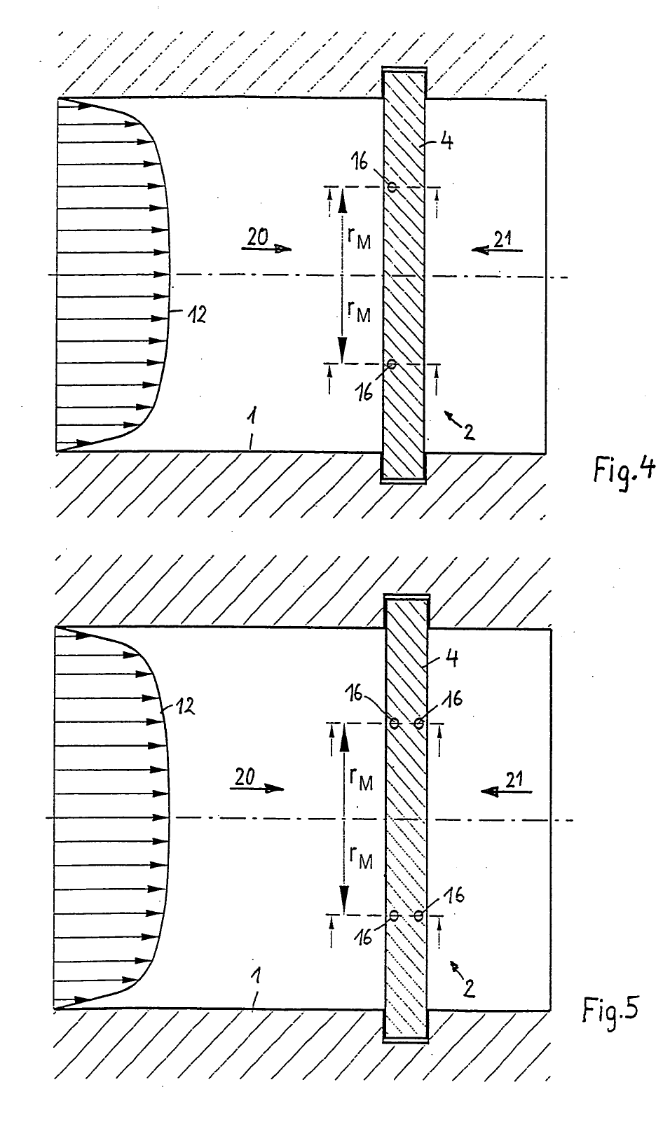

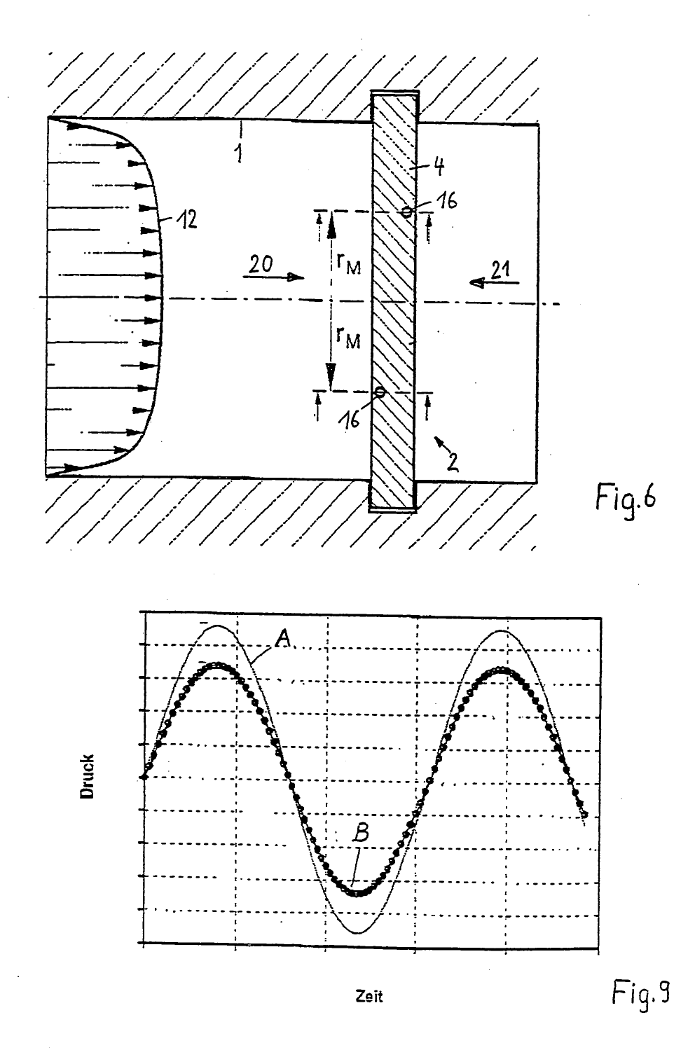

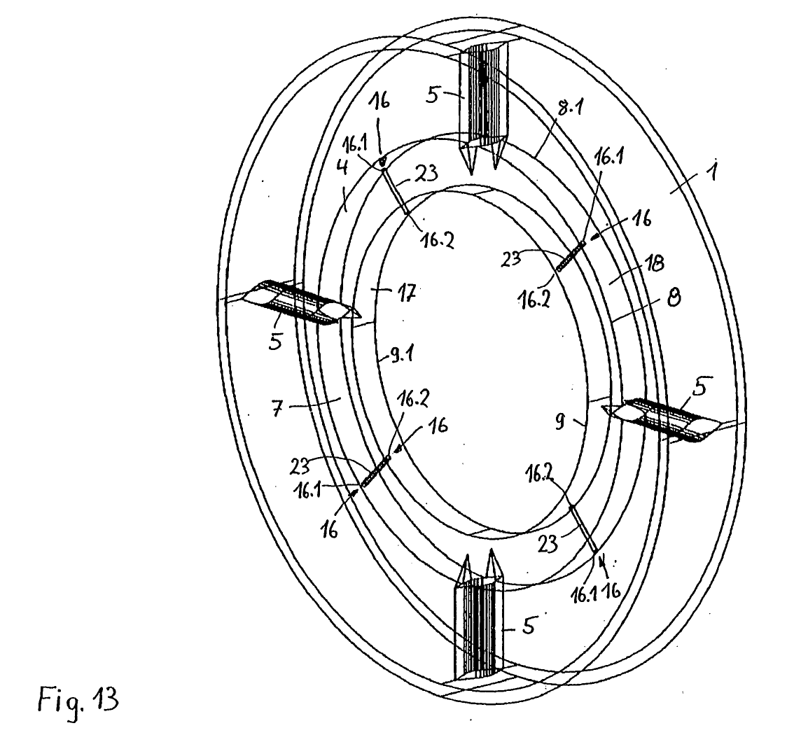

FIG. 11 a section B-B according to FIG. 3 enlarged in scale;

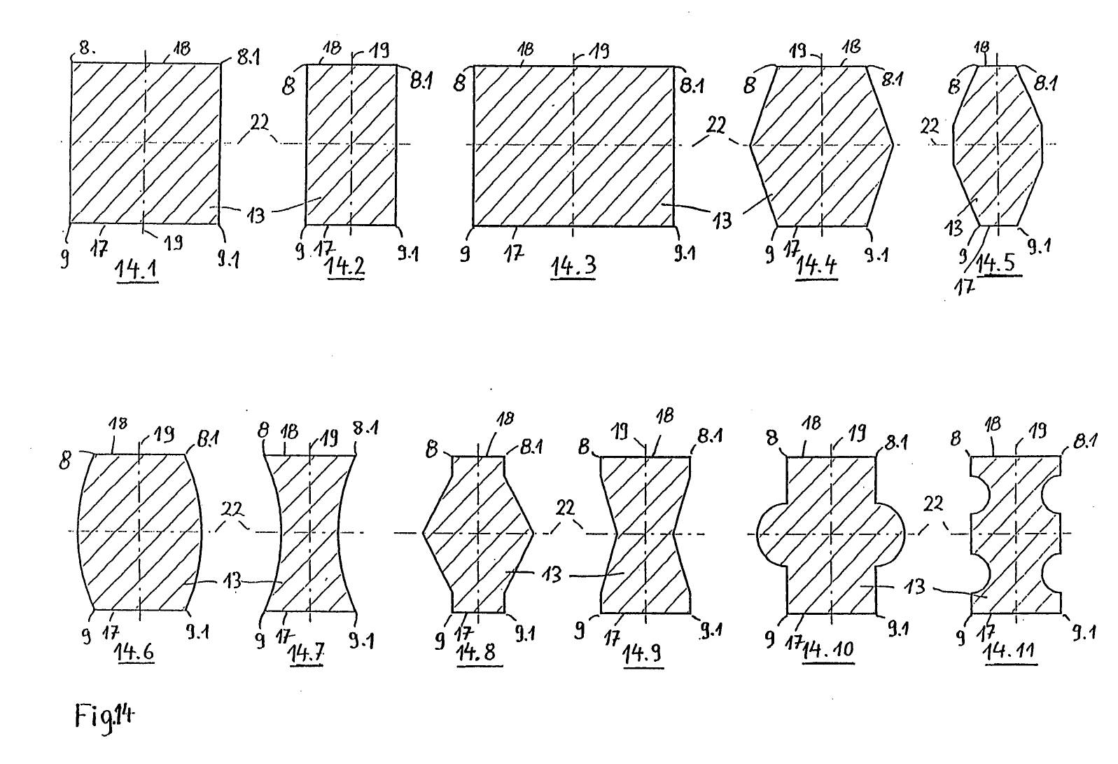

FIGS. 12, 13 perspective views of vortex frequency flow meters with a ring shaped obstructor and various sensor arrangements; and

FIG. 14 various possible cross sections of obstructors.

FIG. 1 shows a pipeline 1 in which a vortex frequency flow meter 2 is mounted. Said flow meter consists of an exterior clamping ring 3 and an interior obstructor ring 4, said obstructor ring 4 being rigidly connected with the clamping ring 3 by means of three bars disposed radially in angular spacements of 120° (not shown in FIG. 1). Such bars 5 are shown in FIGS. 12 and 13, whereby in these examples two or four, respectively, bars 5 provided for holding the obstructor ring 4. Clamping ring 3 serves for mounting the vortex frequency flow meter 2 inside the pipeline 1 in that being clamped between two flanges not shown in detail here. Interior cross section corresponds to the interior cross section R₀ of the pipeline 1, so that the interior wall 6 of this is continued by the interior side of the clamping ring 3 and no vorteces ensue this point. The surface 7 of the obstructor ring 4 facing the flow (the direction of flow is indicated by the arrow 20) is designed as a flowwise blunt surface oriented perpendicular in relation to the flow which is limited internally and on the outside by sharp shedding edges 8 and 9. At these shedding edges 8, 9 ring vorteces 10 and 11 are shedded alternatingly with identical frequency whereby the ring vorteces 10 with larger diameters are associated with the shedding edge 8 and the ring vorteces 11 with smaller cross sections are associated with the shedding edge 9. As the obstructor ring 4 is held by the bars concentrically inside the pipeline 1 in case of a fully developed pipeflow, said obstructor ring lies on a circular curve of equal velocity as can be seen from the turbulent velocity profile 12 shown in FIG. 1. Thus, the vortex shedding can happen in a very homogeneous manner, so that the ring vorteces 10 and 11, respectively, remain active for a relativ long period behind the vortex frequency flow meter 2 as a so-called von-Karman vortex street before they become dissolved.

With the rod and ring shaped obstructors 4 chozen for the example embodiments the cross sections 13 thereof are rectangular. Such a cross section 13 is symmetrical in relation to its two main axes 19, 22 in the direction of flow and perpenducular thereto 20, 21, so that identical parameters ensue when the vortex frequency flow meter 2 is hit with fluid against the direction of flow 21 (FIG. 1) (the vorteces 10, 11 then detach themselves from the shedding edges 8.1 and 9.1). In other words, with such a cross section a certain flow velocity leads to an identical frequency for both directions of flow. Despite the option of measuring the volume flow in both directions the complexity of signal processing thus remains low.

In FIG. 14, by way of example, further cross sections 13 of the obstructors 4 are shown allowing measurements to be taken in both directions of flow. In the illustrations below we continue to use a rectangular cross section by way of example (FIGS. 14.2, 14.3), while it is noted, however, that what is said is equally aplicable to other cross sections.

The sensors built into the obstructor ring 4 are microsensors 16 (FIGS. 10, 11). They are merely indicated symbolically by circles in FIGS. 2 through 8 and 12 and 13. As explained above, the vorteces shedded at the shedding edges 8, 9 or 8.1, 9.1, respectively, lead to local variations in velocity and pressure. Thus, all measuring principles are suitable which allow a detection of these values or of parameters dependent upon these values. Examples for suitable sensors would thus include: differential pressure sensors, absolute pressure sensors, total flow resistance sensors, flow friction sensors, heat dissipation sensors and heat distribution sensors. Such sensor types are generally known to the expert in the art, so that these construction principles can be converted into microtechnology, i.e. these known types of sensors can be miniturized. The microsensors 16 are thus shown in black box type in FIG. 10, 11 as only the measuring principle realized by means of the microsensors is of relevance, not the exact design thereof.

In the chosen embodiment examples differential micropressure sensors 16 are being utilized while the invention is by no means limited to such sensors. In measuring by means of differential pressure microsensors 16 two measuring points 16.1 and 16.2 are provided which lie at the lateral surfaces 17, 18 of the cross section 13. The measuring points 16.1, 16.2 are interconnected by a through bore 23. The measuring points 16.1, 16.2 may either be differential pressure microsensors 16 or the outlets of the through bores 23 as shown in FIGS. 10 and 11. Through the through bores 23 the pressure differences on the lateral surfaces 17, 18 are superimposed. As due to the alternating shedding of vorteces increase of pressure on the one side 17, 18 meets with a drop in pressure of approximately equal scale on the other side 18, 17 a doubling of signal amplitude ensues, i.e. the measuring signals amplified largely materially increasing the measuring sensitivity.

The arrangement of sensors for detecting the direction of flow in accordance with the invention is subsequently further illustrated by means of FIGS. 2 through 8. These figures show a vortex frequency flow meter 2 with a rod shaped obstructor 4 built into a pipeline 1. A turbulent flow profile 12 is present.

In principle, one sensor 16 is sufficient for determining the flow volume and the direction of flow. This most simple case is represented in FIG. 2. As can be seen from this drawing, the differential pressure microsensor 16 is disposed at the level of the pipe axis and displaced against the direction of flow 20, i.e. towards the shedding edges 8, 0. With this arrangement the pressure amplitude measured, based upon identical flow velocities, is larger when the flow comes from the direction 20 than if it comes from the direction 21. This is shown in the diagram according to FIG. 9, in which curve A is associated with the direction of flow 20 and curve B with the direction of flow 21. Whether, since one amplitude value can be associated with two frequencies, i.e. two velocities, that is in the direction of flow 20 or 21, this amplitude on its own is not sufficient to determine the direction of flow 20, 21. What must be utilized in addition is a field of characteristic and data of frequency amplitude pairs determined under defined conditions with which the actual measures values can be compared. Thus, in an arrangement with only one displaced sensor 16, there is an increased complexity of date processing.

This complexity is avoided using an arrangement according to FIG. 3. Hereby, two differential pressure microsensors 16 are provided which are disposed at the same level, in this case at the level of the pipe axis. Both differential pressure microsensors 16 are similarly displaced as against the main axis 19 of the cross section 13 towards the shedding edges 8, 8.1 and 9, 9.1, respectively (FIG. 11). This displacement of sensors 16 against the two directions of flow 20, 21 increases the certainty of determination of direction and predominantly reduces the complexity of date processing, because a comparison of signal amplitudes can be executed directly (FIG. 9) without having to revert to a stored field of characteristic data as in the arrangement according to FIG. 2. A further advantage as opposed to that arrangement lies in an increased redundancy of measurements.

Moreover, an increased redundancy of measurements as opposed to the arrangement according to FIG. 2 is obtained by a sensor distribution according to FIG. 4. Hereby, two differential pressure microsensors 16 are displaced in the same direction, i.e. towards the shedding edges 8, 9 by equal distances, whereby the distance r_{M} of the sensors 16 in relation to the pipe axes is identical. Besides a determination of the flow volume and the direction of flow 20, 21, this arrangement allows the detection of flow asymmetries if a respective complexity of date processing is utilized. As regards the detection of the direction of flow 20, 21, there is the same disadvantage as with the sensor arrangement according to FIG. 2. However, this disadvantage can be overcome, in a manner analogue to the solution according to FIG. 3, by doubling the sensors 16, als shown in FIG. 5.

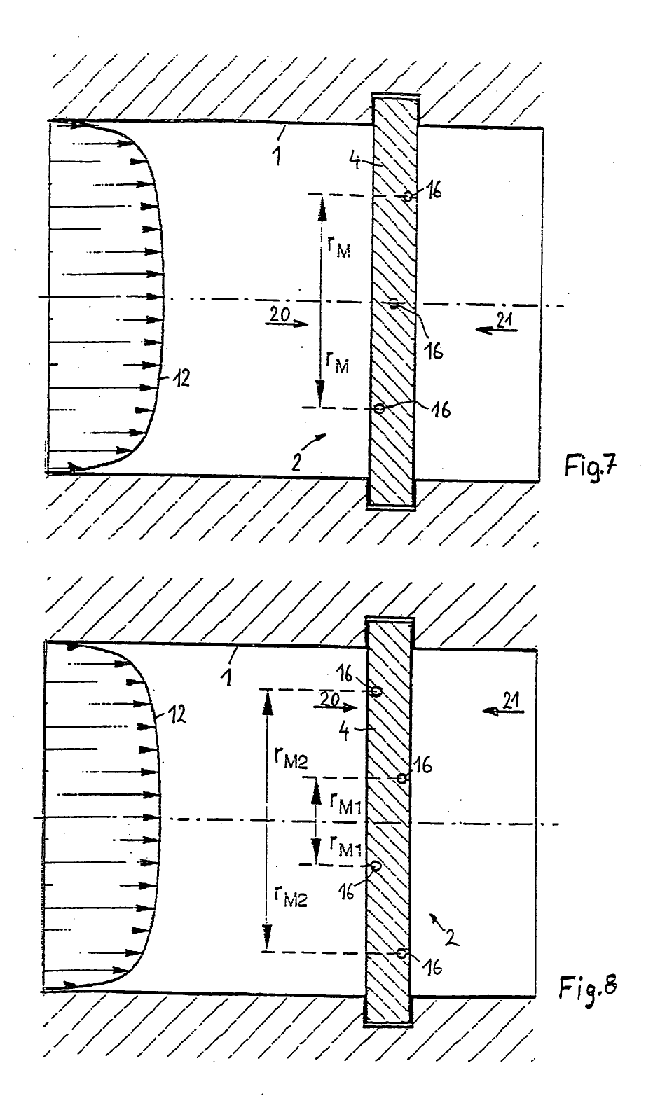

However, this disadvantage is avoidable by means of a more simple solution shown in FIG. 6. Hereby, two differential pressure microsensors 16 disposed at equal distances r_{M} from the pipe axes are disposed displaced in opposing directions. As these sensors, in a case of symmetrical flow, detect equal local flow velocities, i.e. frequencies, owing to the equality of distance in relation to the pipe axis, this arrangement corresponds to the sensor arrangement according to FIG. 3, as regards the detection of the direction of flow 20, 21, while offering the advantage of allowing the detection of flow asymmetries.

It is apparent that increasing the number of sensors 16 distributed over the height of the obstructor 4 increases the accuracy of detection of asymmetries. FIG. 7 shows a sensor arrangement in which a third, central measuring point is added to the arrangement shown in FIG. 6. As there exists no comparison position for this central position it is disposed centrically between the shedding edges 8, 9 and 8.1, 9.1. It would also be conceivable to displace this central measuering point in the one or the other direction of flow 20, 21 in order to maximize the signal amplitude of this measuring point for a certain main direction of flow 20, 21.

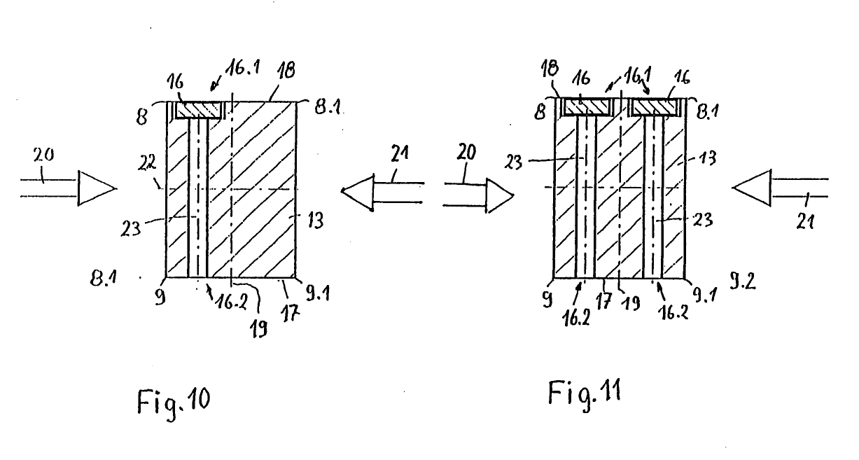

FIG. 8 shows an obstructor 4 with four differential pressure microsensors 16 displaced in pairs, whereby the differential pressure microsensors 16 of one pair always exhibit equal distances r_{M1} or r_{M2} from the pipe axis. Similarly to the arrangement according to FIG. 5, this arrangement leads to a redundancy as regards the detection of the direction of flow 20, 21.

As a further variation of a displacement of measuring points it would be conceivable to displace all measuring points below the pipe axis into one direction and all measuring points above the pipe axis into the other direction.

FIGS. 12 and 13 show vortex frequency flow meters 2 with ring shaped obstructors 4 whose sensor arrangement is similar to that of FIGS. 6 and 8, respectively. Thus, what was said in relation to rod shapes obstructors 4 applies also for these cases.

1. A vortex frequendy flow meter for detecting the flow volume of a liquid or gaseous medium through a pipeline (1) with an obstructor (bluff body) (4) mounted therein, said obstructor comprising lateral surfaces (17, 19) arranged essentially parallel to the flow and terminating in both directions of flow (20, 21) at vortex shedding edges (8, 8.1; 9, 9.1), whereby the cross section of the obstructor (4) between the shedding edges (8, 8.1; 9, 9.1) in the direction of flow (20, 21) and perpenducular thereto is essentially symmetric and in at least one of the lateral surfaces (17, 18) at least one sensor (16) for detecting vorteces (10, 11) periodically shedding from the shedding edges (8, 8.1; 9, 9.1), characterised in that the at least one sensor (16) for detecting the direction of flow (20, 21) is disposed off-centre—as seen in the direction of flow (20, 21)—between the shedding edges (8, 8.1; 9, 9.1).

2. Vortex frequency flow meter according to claim 1, characterised in that the obstructor (4) is rod shaped, ring shaped or at least partially ring shaped.

3. Vortex frequency flow meter according to claim 1 or 2, characterised in that the at least one sensor (16) is associated with a second sensor (16) disposed in a manner displaced in relation to the first one in the direction of flow (20, 21) and lying in the same thread of flow.

4. Vortex frequency flow meter according to claim 2 or 3, characterised in that at least two sensors (16) are provided which are distributed across the height of the rod shaped or upon the circumference, respectively, of the at least partially ring shaped obstructor (4) and are displaced against each other in the direction of flow (20, 21).

5. Vortex frequency flow meter according to claim 4, characterised in that said sensors (16) are displaced in pairs and the distance of the sensors (16) of one pair from the pipe axis is identical.

6. Vortex frequency flow meter according to one of the claims 3 through 5, characterised in that said sensors (16) are disposed off-centre in opposing directions between the shedding edges (8, 8.1; 9, 9.1).

7. Vortex frequency flow meter according to one of the preceding claims, characterised in that measuring points (16.1, 16.2) disposed on opposite sides of the lateral surfaces (17, 18) of the obstructor (4) are interconnected by a through bore (23).

8. Vortex frequency flow meter according to claim 7, characterised in that said through bores (23) are closed on both sides by membranes aligned in an essentially formfit manner with the surface of the lateral surfaces (17, 18).

9. Vortex frequency flow meter according to one of the preceding claims, characterised in that said sensors (16) are microsensors.
